(19) United States
(12) Patent Application Publication
(10) Pub. No.: US 2024/0409371 A1
(43) Pub. Date: Dec. 12, 2024

(54) ELEVATOR SYSTEM INCLUDING SENSOR ASSEMBLY FOR DETECTING OBJECT LOADING AND UNLOADING

(71) Applicant: Otis Elevator Company, Farmington, CT (US)

(72) Inventors: Randy Roberts, Hebron, CT (US); Johanna Whitwell, Hartford, CT (US); Kathleen Nicole Moore, West Hartford, CT (US); Craig Drew Bogli, Avon, CT (US)

(21) Appl. No.: 18/333,229

(22) Filed: Jun. 12, 2023

(51) Int. Cl. B66B 13/26; B66B 5/00

(52) U.S. Cl. CPC B66B 13/26; B66B 5/0018

(57) ABSTRACT

An elevator system including a hoistway; an elevator car configured to travel in the hoistway; a landing having a landing door; a sensor assembly configured to monitor a field of view overlapping a door opening of the landing door; the sensor assembly configured to perform at least one of (i) determine a number of objects in the elevator car, (ii) determine a load of objects in the elevator car and (iii) detect a door obstruction.

### BACKGROUND

The embodiments described herein relate to elevator systems, and more particularly, to an elevator system including a sensor assembly to detect objects entering and exiting an elevator car.

Existing elevator systems employ a code-required door obstruction detection system. Existing elevator systems may also employ a people counting system and a load detection system and a releveling control system. The door obstruction detection system, people counting system, load detection system and releveling control system are typically implemented using separate devices.

### SUMMARY

According to an embodiment, an elevator system includes a hoistway; an elevator car configured to travel in the hoistway; a landing having a landing door; a sensor assembly configured to monitor a field of view overlapping a door opening of the landing door; the sensor assembly configured to perform at least one of (i) determine a number of objects in the elevator car, (ii) determine a load of objects in the elevator car and (iii) detect a door obstruction.

In addition to one or more of the features described herein, or as an alternative, further embodiments may include wherein the sensor assembly includes a sensor that measures distances to objects.

In addition to one or more of the features described herein, or as an alternative, further embodiments may include wherein the sensor includes at least one of a LIDAR sensor, a millimeter wave RADAR sensor and an RGBD camera.

In addition to one or more of the features described herein, or as an alternative, further embodiments may include wherein the sensor assembly is configured to perform at least two of (i) determine the number of objects in the elevator car, (ii) determine the load of objects in the elevator car and (iii) detect the door obstruction.

In addition to one or more of the features described herein, or as an alternative, further embodiments may include wherein the sensor assembly is configured to perform all of (i) determine the number of objects in the elevator car and (ii) determine the load of objects in the elevator car, and (iii) detect the door obstruction.

In addition to one or more of the features described herein, or as an alternative, further embodiments may include wherein the sensor assembly determines the number of objects in the elevator car by detecting objects entering and existing the elevator car.

In addition to one or more of the features described herein, or as an alternative, further embodiments may include wherein the sensor assembly is configured to communicate the number of objects in the elevator car to an elevator controller.

In addition to one or more of the features described herein, or as an alternative, further embodiments may include wherein the elevator controller is configured to control operation of the elevator system in response to the number of objects in the elevator car.

In addition to one or more of the features described herein, or as an alternative, further embodiments may include wherein the sensor assembly determines the load of the objects in the elevator car by determining a type of each object in the elevator car, wherein each type of object is associated with a weight.

In addition to one or more of the features described herein, or as an alternative, further embodiments may include wherein the sensor assembly determines the type of each object in the elevator car by comparing sensor data from a sensor to reference data in a memory.

In addition to one or more of the features described herein, or as an alternative, further embodiments may include wherein the sensor assembly is configured to communicate the load of the objects in the elevator car to an elevator controller.

In addition to one or more of the features described herein, or as an alternative, further embodiments may include wherein the elevator controller is configured to perform sag compensation in response to the load of the objects in the elevator car.

In addition to one or more of the features described herein, or as an alternative, further embodiments may include wherein the type of each object in the elevator car includes a person and a robot.

In addition to one or more of the features described herein, or as an alternative, further embodiments may include wherein determining the load of objects in the elevator car includes determining a load change of objects in the elevator car.

According to another embodiment, a method of operating an elevator system including a hoistway, an elevator car configured to travel in the hoistway and a landing having a landing door, the method including mounting a sensor assembly to monitor a field of view overlapping a door opening of the landing door; and using the sensor assembly, performing at least one of (i) determine a number of objects in the elevator car (ii) determine a load of objects in the elevator car and (iii) detect a door obstruction.

In addition to one or more of the features described herein, or as an alternative, further embodiments may include wherein using the sensor assembly further includes using a sensor to measure distances to objects.

In addition to one or more of the features described herein, or as an alternative, further embodiments may include wherein using the sensor assembly further includes at least one of a LIDAR sensor, a millimeter wave RADAR sensor and an RGBD camera, and the method further comprises: using the at least one of the LIDAR sensor, the millimeter wave RADAR sensor and the RGBD camera to measure distances to objects.

In addition to one or more of the features described herein, or as an alternative, further embodiments may include wherein determining the load of objects in the elevator car includes determining a load change of objects in the elevator car.

In addition to one or more of the features described herein, or as an alternative, further embodiments may include using the sensor assembly to communicate the number of objects in the elevator car to an elevator controller.

According to another embodiment, a computer program is embodied on a non-transitory computer-readable storage medium, the computer program including instructions for causing a processor to implement a process for operating an elevator system including a hoistway, an elevator car configured to travel in the hoistway, a landing having a landing door and a sensor assembly to monitor a field of view overlapping a door opening of the landing door, the process including using the sensor assembly, performing at least one of (i) determine a number of objects in the elevator car (ii) determine a load of objects in the elevator car and (iii) door obstruction detection.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts an elevator system that may employ various embodiments of the present disclosure;

FIG. 2 depicts an elevator door and sensor assembly in accordance with an embodiment;

FIG. 3 depicts field of view of a sensor assembly in accordance with an embodiment;

FIG. 4 depicts a sensor assembly in accordance with an embodiment;

FIG. 5 depicts a flowchart of a process for controlling an elevator system in accordance with an embodiment;.

FIG. 6 depicts detection of a person in accordance with an embodiment; and

FIG. 7 depicts detection of a person and a robot in accordance with an embodiment.

### DETAILED DESCRIPTION

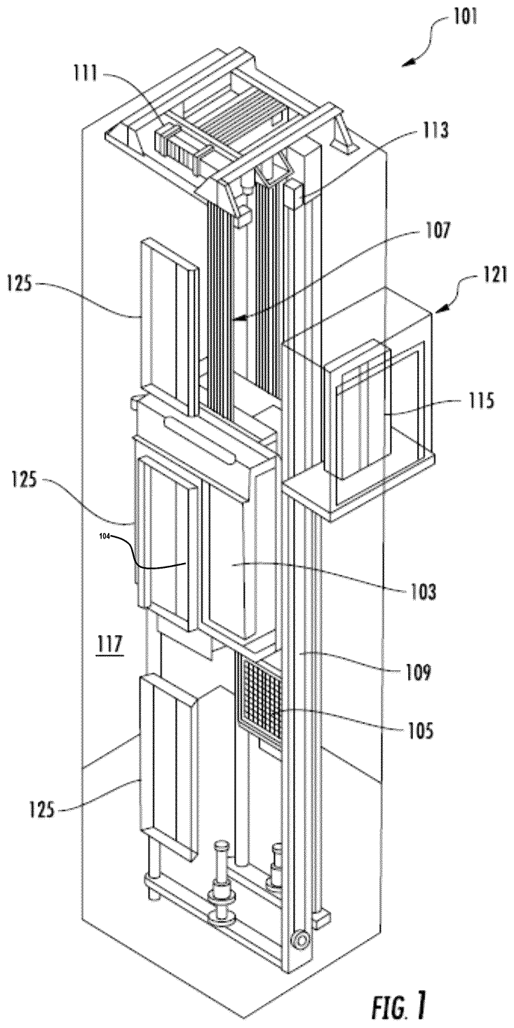

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, motorized wheels to climb beams, pinch wheels or traction wheels). FIG. 1 is merely a non-limiting example presented for illustrative and explanatory purposes.

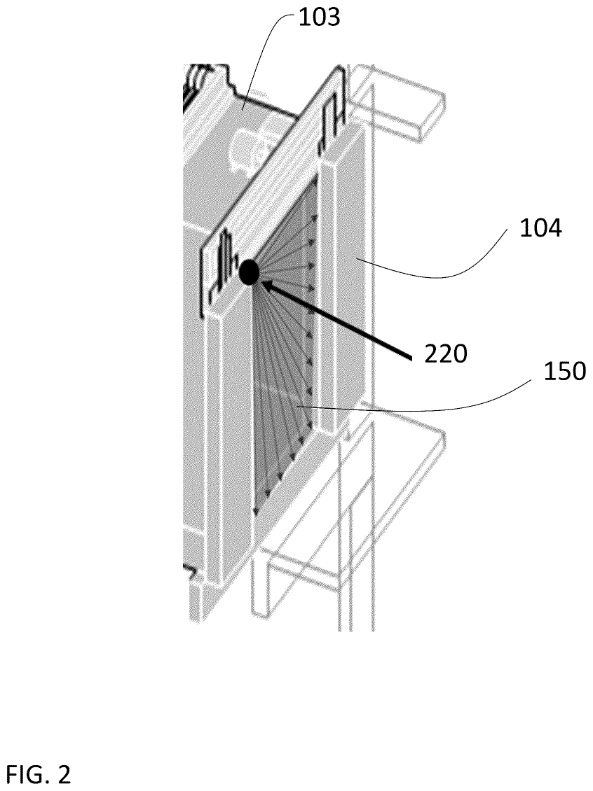

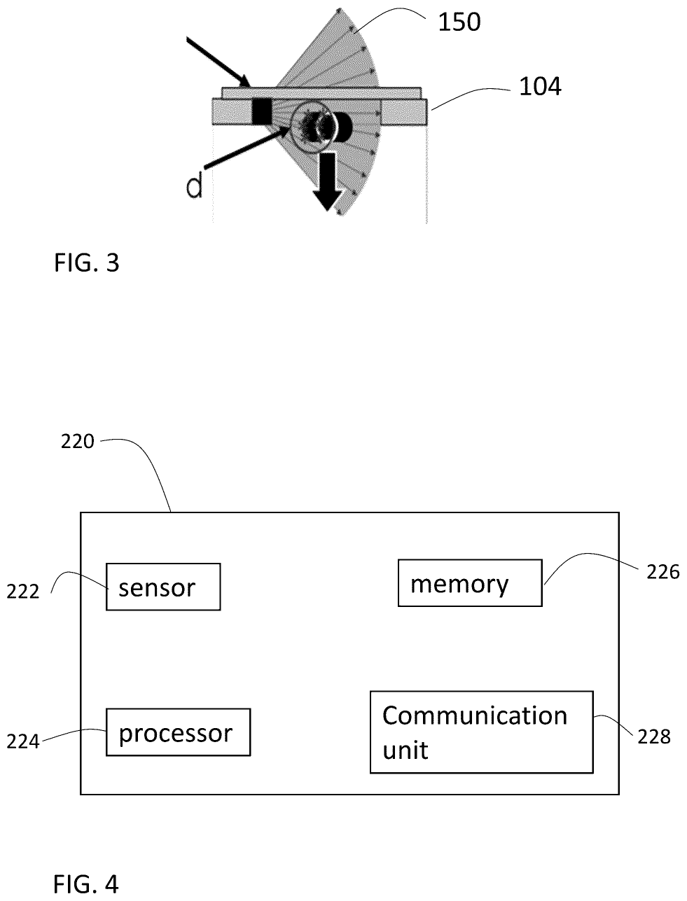

FIG. 2 depicts an elevator door 104 and sensor assembly 220 in an example embodiment. The elevator door 104 in FIG. 2 is a landing door. This sensor assembly 220 may be positioned at a corner of the door 104, with a field of view 150 overlapping a door opening. The field of view 150 may be two-dimensional or three-dimensional. In the example in FIG. 2, the field of view 150 includes 90 degrees in the plane of the opening of door 104 and +or −15 to 25 degrees in the out of plane area, as shown in FIG. 3. FIG. 3 is top down view at door 104. This field of view 150 allows the sensor assembly 220 to obtain sensor data of objects entering the elevator car 103. The sensor data can be post-processed, at the sensor assembly 220, to determine the number, load, and direction of movement of objects. As used herein, objects may include people (adult and child), cargo, robots (e.g., automated guided vehicles), etc.

FIG. 4 depicts a sensor assembly 220 in an example embodiment. The sensor assembly 220 includes a sensor 222. The sensor 222 may be a distance sensor that generates distance measurements in a two-dimensional or three-dimensional field of view 150. The sensor 222 may be implemented using a LIDAR sensor, a millimeter wave RADAR sensor, an RGBD camera or other distance measuring sensors. The sensor assembly 220 includes a processor 224 that controls operation of the sensor assembly 220. The processor 224 may be implemented using a general-purpose microprocessor executing a computer program stored on a storage medium to perform the operations described herein. Alternatively, the processor 224 may be implemented in hardware (e.g., ASIC, FPGA) or in a combination of hardware/software. The processor 224 allows the sensor assembly 220 to perform computations locally, also referred to as edge computing. The processor 224 can send commands to other components of the elevator system 101 based on a result of the local computations.

The sensor assembly 220 includes a memory 226 that may store a computer program executable by processor 224, reference data, sensor data, etc. The memory 226 may be implemented using known devices such a random access memory. The sensor assembly 220 includes a communication unit 228 which allows the sensor assembly 220 to communicate with other components of the elevator system 101, such as the elevator controller 115. The communication unit 228 may be implemented using wired connections (e.g., LAN, ethernet, twisted pair, etc.) or wireless connections (e.g., WiFi, NFC, BlueTooth, etc.).

In operation, the sensor assembly 220 can perform a local determination of objects entering and exiting the elevator car 103. The sensor assembly 220 can perform a count of objects entering and exiting the elevator car 103, and provide this count to the elevator controller 115. The sensor assembly 220 can also determine a car load as objects enter and exit the elevator car 103. The car load may be used for sag compensation, as described herein.

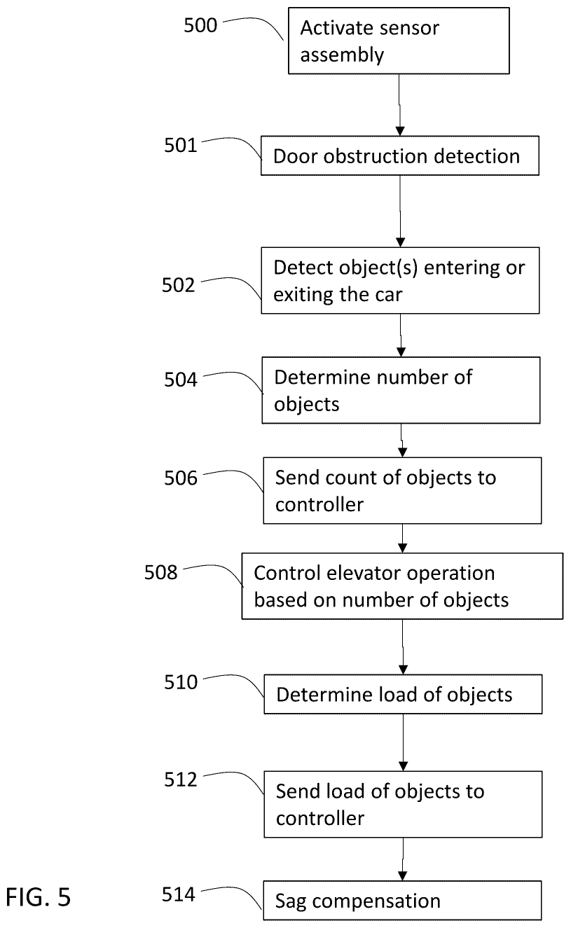

FIG. 5 depicts a flowchart of a process for controlling an elevator system in an example embodiment. At 500, a sensor assembly 220 at an elevator car door 104 is activated. In an example embodiment, the sensor assembly 220 is constantly active and acquiring sensor data. In alternate embodiments, the sensor assembly 220 may be activated when an elevator car 103 stops at a landing or only when door 104 is opened. This can conserve power usage and reduce unneeded sensor data.

At 501, the sensor assembly 220 provides door obstruction detection. The sensor assembly 220 initiates door obstruction detection upon opening of the door 104, which is required by certain codes. Upon detecting an object in the field of view 150, the sensor assembly 220 can prevent movement of the door 104 or command movement of the door 104 to an open position. The sensor assembly 220 may communicate with a door controller in the elevator car 103 to control motion of the door 104.

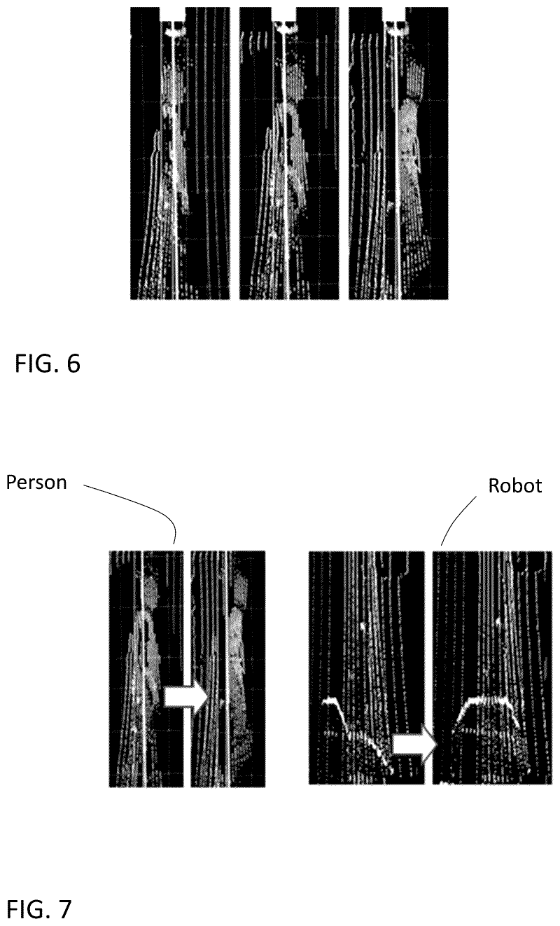

At 502, the sensor assembly 220 detects object(s) entering or exiting the elevator car 103. The detection of objects entering or exiting the elevator car 103 is performed by the processor 224. The sensor 222 generates distance data representative of the distance of an object from the sensor 222. FIG. 6 depicts distance data obtained by the sensor 222 when a person enters the elevator car 103. Background distance measurements are collected to establish the baseline when no objects are in the doorway. Objects (humans, robots, cargo, etc.) can then be classified by the processor 224 as they appear in the foreground (in front of) the learned ambient background. The distance data obtained by the sensor 222 can be compared to a threshold to confirm that the object is of sufficient size to be labeled as an object. For example, if the sensor 222 generates a number of points per scan of the field of view 150, the number of points must be greater than a threshold to confirm that an object is present. The direction of travel of the object is also determined (e.g., by comparing point distributions across multiple frames of the field of view 150) to verify if the object is entering or exiting the elevator car 103.

At 504, the sensor assembly 220 determines the number of objects in the elevator car 103. An object may be any item of sufficient size to be a factor in operation of the elevator system 101. Example objects include people (adult and child), cargo, robots, etc.

At 506, the sensor assembly 220 sends the count of objects in the elevator car 103 to the elevator controller 115. This may occur using the communication unit 228.

At 508, the elevator controller 115 can then control operation of the elevator system 101 based on the number of objects in the elevator car 103. The number of objects in the elevator car 103 can affect a number of parameters of operation of the elevator system 101. For example, if the elevator car 103 is full (e.g., the number of objects is greater than a limit) then the elevator controller 115 will not assign additional calls to the full elevator car 103. Determining the number of objects in the elevator car 103 can also be helpful in detecting “piggy backing.” in which a single destination call is made, but a group of people board the elevator car 103 all traveling to the same destination floor. The number of objects in the elevator car 103 can also be used to pre-torque the machine 111 so that the elevator car 103 does not rise or drop when the machine brake is lifted. The number of objects in the elevator car 103 can also be used to adjust open and close times of the door 104. A less crowded elevator car 103 can utilize shorter open and close times of the door 104, resulting in faster travel times.

At 510, the sensor assembly 220 determines a load of the objects in the elevator car 103. Determining the load of the objects may be performed by classifying each object as a type of object. Memory 226 of the sensor assembly 220 may store a weight associated with each type of object. FIG. 7 shows examples of two types of objects, a person and a robot. The sensor assembly 220 can classify these objects based on the sensor data from sensor 222. The data from sensor 222 may be considered camera or photo images, include range data (also referred to as depth) for each pixel in the image. This added sensory input from the range of depth sensors enables a robust classification of objects. The processor 224 may compare sensor data from sensor 222 to reference data in memory 226. The reference data in memory 226 may include reference data for multiple types of objects, such as people (adult and child), cargo, robots, etc. When the sensor data from sensor 222 matches reference data in memory 226, the type of object is determined.

Determining the load at 514 may include determining a load change in the elevator car 103, rather than a total load. As described in further detail herein, sag compensation may be performed based on load change eliminating the need to determine total load in the elevator car 103.

Each type of object is associated with a weight in memory 226. For example, a person may be associated with a weight of 70 kilograms and a robot associated with a weight of 150 kilograms. Unclassified objects (e.g., objects assigned a type of “unknown” that do not match any reference data) may be assigned a default weight. The sensor assembly 220 accumulates the weights associated with each type of object in the elevator car 103 and sends a load of the elevator car 103 the elevator controller at 512.

At 514, the elevator controller 115 performs a sag compensation process. Sag refers to the tension member(s) 107 being elongated due to factors including load in the elevator car 103, location of the elevator car 103 in the hoistway 117, the number, size and type of tension members 107, etc. Elongation of the tension member 107 can cause the elevator car 103 to be misaligned with a landing sill when the elevator car 103 is parked at a landing creating a tripping hazard for passengers or an uneven surface creating issues for moving cargo or robots across the sill.

Based on the load in the elevator car 103, and other factors, the elevator controller 115 determines a sag compensation value that corresponds to a distance that the elevator car 103 needs to be moved in order to compensate for sag. The elevator controller 115 causes the machine 111 to move the elevator car 103 to compensate for sag. As noted above, the sensor assembly 220 determines a load in the elevator car 103, which may be a total load or load change. The controller 115 would know the landing being served and stores in its local memory an estimate of the tension member 107 (ropes or belts) stiffness at that landing location. The sag compensation may be determined by the load change divided by the controller 115 storage value of rope stiffness at the noted landing location. The sag compensation by the controller 115 could smooth out load changes (loads and unloads) over time and also limit the compensation's rate of change to avoid abrupt car movements.

The controller 115 may integrate the sag compensation at 514 to an existing baseline releveling mode that adjusts motor position based on a sensed amount of car sag, from position vanes or the position reference system 113. The baseline releveling function is reactive using feedback. The sag compensation at 514 is proactive using feedforward logic that can be added (or integrated) with the feedback logic's motor command.

The steps of FIG. 5 may be repeated as needed.

Embodiments described herein allow for a single sensor assembly that provides the code-mandated function of door obstruction monitoring and also, when combined with data processing, can isolate and count passengers and their movement into or out of the elevator car. This information can be used to optimize elevator operation, such as dispatching and group control while not violating privacy concerns associated with camera-based monitoring systems. This type of usage data is not currently available using existing elevator sensors such as load weighing which only monitor the change in load, but don't detect or measure individual load transfers out of and into the elevator at each stop. Embodiments also provide a solution to the elevator sag issue by using the sensor assembly to monitor the time varying load transfer data and incorporate that as an open-loop feedforward compensation to limit dynamic sag.

As described above, embodiments can be in the form of processor-implemented processes and devices for practicing those processes, such as a processor 224 in the sensor assembly 220. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
a hoistway;
an elevator car configured to travel in the hoistway;
a landing having a landing door;
a sensor assembly configured to monitor a field of view overlapping a door opening of the landing door;
wherein the sensor assembly is configured to perform at least one of (i) determine a number of objects in the elevator car, (ii) determine a load of objects in the elevator car and (iii) detect a door obstruction.

2. The elevator system of claim 1, wherein the sensor assembly includes a sensor that measures distances to objects.

3. The elevator system of claim 2, wherein the sensor includes at least one of a LIDAR sensor, a millimeter wave RADAR sensor and an RGBD camera.

4. The elevator system of claim 1, wherein the sensor assembly is configured to perform at least two of (i) determine the number of objects in the elevator car, (ii) determine the load of objects in the elevator car and (iii) detect the door obstruction.

5. The elevator system of claim 1, wherein the sensor assembly is configured to perform all of (i) determine the number of objects in the elevator car and (ii) determine the load of objects in the elevator car, and (iii) detect the door obstruction.

6. The elevator system of claim 1, wherein the sensor assembly determines the number of objects in the elevator car by detecting objects entering and existing the elevator car.

7. The elevator system of claim 1, wherein the sensor assembly is configured to communicate the number of objects in the elevator car to an elevator controller.

8. The elevator system of claim 7, wherein the elevator controller is configured to control operation of the elevator system in response to the number of objects in the elevator car.

9. The elevator system of claim 1, wherein the sensor assembly determines the load of the objects in the elevator car by determining a type of each object in the elevator car, wherein each type of object is associated with a weight.

10. The elevator system of claim 9, wherein the sensor assembly determines the type of each object in the elevator car by comparing sensor data from a sensor to reference data in a memory.

11. The elevator system of claim 9, wherein the sensor assembly is configured to communicate the load of the objects in the elevator car to an elevator controller.

12. The elevator system of claim 11, wherein the elevator controller is configured to perform sag compensation in response to the load of the objects in the elevator car.

13. The elevator system of claim 9, wherein the type of each object in the elevator car includes a person and a robot.

14. The elevator system of claim 1, wherein determining the load of objects in the elevator car includes determining a load change of objects in the elevator car.

15. A method of operating an elevator system including a hoistway, an elevator car configured to travel in the hoistway and a landing having a landing door, the method comprising:
mounting a sensor assembly to monitor a field of view overlapping a door opening of the landing door; and
using the sensor assembly, performing at least one of (i) determine a number of objects in the elevator car (ii) determine a load of objects in the elevator car and (iii) detect a door obstruction.

16. The method of claim 15, wherein using the sensor assembly further includes using a sensor to measure distances to objects.

17. The method of claim 15, wherein using the sensor assembly further includes at least one of a LIDAR sensor, a millimeter wave RADAR sensor and an RGBD camera, and the method further comprises:
using the at least one of the LIDAR sensor, the millimeter wave RADAR sensor and the RGBD camera to measure distances to objects.

18. The method of claim 15, wherein determining the load of objects in the elevator car includes determining a load change of objects in the elevator car.

19. The method of claim 15, further comprising using the sensor assembly to communicate the number of objects in the elevator car to an elevator controller.

20. A computer program embodied on a non-transitory computer-readable storage medium, the computer program including instructions for causing a processor to implement a process for operating an elevator system including a hoistway, an elevator car configured to travel in the hoistway, a landing having a landing door and a sensor assembly to monitor a field of view overlapping a door opening of the landing door, the process comprising:
using the sensor assembly, performing at least one of (i) determine a number of objects in the elevator car (ii) determine a load of objects in the elevator car and (iii) door obstruction detection.
